(19) United States
(12) Patent Application Publication
(10) Pub. No.: US 2009/0190245 A1
(43) Pub. Date: Jul. 30, 2009

(54) HEAD EVALUATION METHOD, MAGNETIC STORAGE APPARATUS AND COMPUTER-READABLE STORAGE MEDIUM

(75) Inventor: Chiharu Nakata, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/259,201

(22) Filed: Oct. 27, 2008

(30) Foreign Application Priority Data
Jan. 30, 2008 (JP) 2008-019315

(51) Int. Cl. G11B 27/36

(52) U.S. Cl. 360/31

(57) ABSTRACT

A head evaluation method obtains a first measured result indicating a change in read data, by writing data on and reading data from the disk rotated at a first speed, and reading the data from the disk rotated at a second speed higher than the first speed while maintaining a floating amount of a head the same as that when the disk is rotated at the first speed. A second measured result indicating a change in read data is obtained by writing data on and reading data from the disk rotated at the second speed, and reading the data from the disk rotated at the first speed while maintaining the floating amount of the head the same as that when the disk is rotated at the second speed. The head is evaluated based on the first and second measured results, and a primary factor of a characteristic change of the head depending solely on a transfer rate is evaluated.

### BACKGROUND OF THE INVENTION

1. Field of the Invention

The present invention generally relates to head evaluation methods, magnetic storage apparatuses and computer-readable storage media, and more particularly to a head evaluation method, a magnetic storage apparatus and a computer-readable storage medium for evaluating a primary factor of a characteristic change of a magnetic head that depends on a transfer rate.

2. Description of the Related Art

Recently, the recording density and the transfer rate of magnetic disks (hard disks) have increased considerably. Particularly in magnetic disk apparatuses (or magnetic disk drives) which are used in information processing apparatuses such as high-end servers, there are demands to further increase the data transfer rate at which the data are recorded (that is, written) on and reproduced (that is, read) from the magnetic disk by rotating the magnetic disk at a high speed.

If the data transfer rate is high, there is a tendency for the read and/or write characteristic (or performance) of the magnetic head to deteriorate compared to the case where the transfer rate is low. For this reason, it is necessary to evaluate the effects of increasing the data transfer rate on the deterioration of the read and/or write characteristic. Conventionally, there is a method of evaluating the read and/or write characteristic from an error rate of read data with respect to write rate, for example, by fixing a Bit Per Inch (BPI), which is the recording density in a direction in which a track extends (or, a main scan direction of the magnetic head) on the magnetic disk, and writing and reading the data at different radial positions on the magnetic disk. The data is written and read at different radial positions on the magnetic disk because the peripheral speed of the magnetic disk differs depending on the radial position. But because this conventional method makes the measurements at the different radial positions on the magnetic disk, the measured results are affected by in-plane inconsistencies of the characteristic caused by extremely small undulations or the like existing on the surface of the magnetic disk. The measured results are also affected by a change in the yaw angle of the magnetic head with respect to the disk depending on the radial position because the magnetic head is provided at a tip end of an arm which pivots, and by a change in the distance between the magnetic head and the magnetic disk because the peripheral speed of the magnetic disk differs depending on the radial position. For this reason, it is extremely difficult to evaluate, from the measured results, the primary factor of the characteristic change of the magnetic head that depends solely on the transfer rate. In addition, it is also difficult to distinguish, from the measured results, the effects of the write system from the effects of the read system.

A Japanese Laid-Open Patent Application No. 1-100482 proposes a method of testing the magnetic disk by writing information with a normal write current while rotating the magnetic disk at a rotational speed lower than a normal rotational speed and reading the written information to perform an error check. A Japanese Laid-Open Patent Application No. 2006-147119 proposes a method of reproducing information which saves power by varying the rotational speed of an optical disk depending on the needs. A Japanese Laid-Open Patent Application No. 5-20635 proposes a method of controlling a floating amount of the magnetic head with respect to the magnetic disk by controlling a heater that is provided on the magnetic head.

Conventionally, there was a problem in that it is extremely difficult to evaluate, from the measured results, the primary factor of the characteristic change of the magnetic head that depends solely on the transfer rate.

### SUMMARY OF THE INVENTION

Accordingly, it is a general object of the present invention to provide a novel and useful head evaluation method, magnetic storage apparatus and computer-readable storage medium, in which the problems described above are suppressed.

Another and more specific object of the present invention is to provide a head evaluation method, a magnetic storage apparatus and a computer-readable storage medium, which can evaluate, from a measured result, a primary factor of a characteristic change of a magnetic head that depends solely on a transfer rate.

According to one aspect of the present invention, there is provided a head evaluation method comprising a first procedure obtaining a first measured result which indicates a change in read data, by rotating a magnetic disk at a first rotational speed and writing data on and reading data from the magnetic disk by a magnetic head, and reading the data from the magnetic disk by the magnetic head by rotating the magnetic disk at a second rotational speed which is higher than the first rotational speed while maintaining a floating amount of the magnetic head with respect to the magnetic disk the same as that when the magnetic disk is rotated at the first rotational speed; a second procedure obtaining a second measured result which indicates a change in read data, by rotating the magnetic disk at the second rotational speed and writing data on and reading data from the magnetic disk by the magnetic head, and reading the data from the magnetic disk by the magnetic head by rotating the magnetic disk at the first rotational speed while maintaining the floating amount of the magnetic head with respect to the magnetic disk the same as that when the magnetic disk is rotated at the second rotational speed; and an evaluation procedure evaluating the magnetic head based on the first and second measured results, and evaluating a primary factor of a characteristic change of the magnetic head depending solely on a transfer rate. Hence, it is possible to evaluate, from the measured result, a primary factor of a characteristic change of the magnetic head that depends solely on the transfer rate.

According to another aspect of the present invention, there is provided a magnetic storage apparatus comprising a magnetic head having a heater; a position control part configured to control a radial position of the magnetic head on a magnetic disk; a rotation control circuit configured to control a rotational speed of the magnetic disk; a storage part configured to store a relationship between a floating amount of the magnetic head with respect to the magnetic disk and a rotational speed of the magnetic disk which are measured in advance; a control process part configured to obtain a first measured result which indicates a change in read data, by rotating the magnetic disk at a first rotational speed and writing data on and reading data from the magnetic disk by the magnetic head, and reading the data from the magnetic disk by the magnetic head by rotating the magnetic disk at a second rotational speed which is higher than the first rotational speed while maintaining a floating amount of the magnetic head with respect to the magnetic disk the same as that when the magnetic disk is rotated at the first rotational speed, and to obtain a second measured result which indicates a change in read data, by rotating the magnetic disk at the second rotational speed and writing data on and reading data from the magnetic disk by the magnetic head, and reading the data from the magnetic disk by the magnetic head by rotating the magnetic disk at the first rotational speed while maintaining the floating amount of the magnetic head with respect to the magnetic disk the same as that when the magnetic disk is rotated at the second rotational speed; and an evaluating process part configured to evaluate the magnetic head based on the first and second measured results, and to evaluate a primary factor of a characteristic change of the magnetic head depending solely on a transfer rate, wherein the control process part controls the floating amount of the magnetic head with respect to the magnetic disk by controlling a driving current supplied to the heater based on the relationship stored in the storage part. Hence, it is possible to evaluate, from the measured result, a primary factor of a characteristic change of the magnetic head that depends solely on the transfer rate.

According to still another aspect of the present invention, there is provided a computer-readable storage medium storing a program which, when executed by a computer, causes the computer to perform a process comprising a first procedure obtaining a first measured result which indicates a change in read data, by rotating a magnetic disk at a first rotational speed and writing data on and reading data from the magnetic disk by a magnetic head, and reading the data from the magnetic disk by the magnetic head by rotating the magnetic disk at a second rotational speed which is higher than the first rotational speed while maintaining a floating amount of the magnetic head with respect to the magnetic disk the same as that when the magnetic disk is rotated at the first rotational speed; a second procedure obtaining a second measured result which indicates a change in read data, by rotating the magnetic disk at the second rotational speed and writing data on and reading data from the magnetic disk by the magnetic head, and reading the data from the magnetic disk by the magnetic head by rotating the magnetic disk at the first rotational speed while maintaining the floating amount of the magnetic head with respect to the magnetic disk the same as that when the magnetic disk is rotated at the second rotational speed; and an evaluation procedure evaluating the magnetic head based on the first and second measured results, and evaluating a primary factor of a characteristic change of the magnetic head depending solely on a transfer rate. Hence, it is possible to evaluate, from the measured result, a primary factor of a characteristic change of the magnetic head that depends solely on the transfer rate.

Other objects and further features of the present invention will be apparent from the following detailed description when read in conjunction with the accompanying drawings.

### BRIEF DESCRIPTION OF THE DRAWINGS

FIG. 1 is a block diagram showing a part of a magnetic disk apparatus;

FIG. 2 is a block diagram showing a structure of a control part shown in FIG. 1;

FIGS. 3A and 3B respectively are diagrams showing a relationship between a magnetic disk and a magnetic head;

FIG. 4 is a flow chart for explaining a head evaluation method;

FIG. 5 is a diagram showing a relationship between floating amounts of magnetic heads and a rotational speed of the magnetic disk;

FIGS. 6A, 6B and 6C respectively are diagrams for explaining control of the floating amount of the magnetic head;

FIGS. 7A, 7B and 7C respectively are diagrams for explaining the control of the floating amount of the magnetic head;

FIG. 8 is a diagram showing an output (μV) of the magnetic head at a time of reading when steps S4 and S5 are carried out at a BPI of 100 k;

FIG. 9 is a diagram showing an output (μV) of the magnetic head at a time of reading when the steps S4 and S5 are carried out at a BPI of 400 k;

FIG. 10 is a diagram showing an output (μV) of the magnetic head at a time of reading when steps S6 and S7 are carried out at a BPI of 100 k;

FIG. 11 is a diagram showing an output (μV) of the magnetic head at a time of reading when the steps S6 and S7 are carried out at a BPI of 400 k; and

FIG. 12 is a diagram showing measured results of FIGS. 8 through 11 together.

### DESCRIPTION OF THE PREFERRED EMBODIMENTS

According to one embodiment of the present invention, a data write and a data read are carried out by a magnetic head while rotating a magnetic disk at a first rotational speed, and a data read is thereafter carried out by the magnetic head while rotating the magnetic head at a second rotational speed which is higher than the first rotational speed while maintaining a floating amount of the magnetic head with respect to the magnetic disk the same as that when the magnetic disk is rotated at the first rotational speed, to obtain a first measured result indicating a change in the read data. In addition, a data write and a data read are carried out by the magnetic head while rotating the magnetic disk at the second rotational speed, and a data read is thereafter carried out by the magnetic head while rotating the magnetic head at the first rotational speed which is lower than the second rotational speed while maintaining the floating amount of the magnetic head with respect to the magnetic disk the same as that when the magnetic disk is rotated at the second rotational speed, to obtain a second measured result indicating a change in the read data. The magnetic head is evaluated based on the first and second measured results that are obtained. As a result, it is possible to evaluate, from the first and second measured results, the primary factor of the characteristic change of the magnetic head that depends solely on the transfer rate.

It is possible to further obtain the recording density (BPI) at which the effects of the transfer rate are reduced, by comparing a first measured result that is obtained when the recording density (BPI) in the main scan direction of the magnetic head (or, in a circumferential direction of the magnetic disk) is low and a first measured result that is obtained when the recording density (BPI) in the main scan direction of the magnetic head is high, and comparing a second measured result that is obtained when the recording density (BPI) in the main scan direction of the magnetic head is high and a second measured result that is obtained when the recording density (BPI) in the main scan direction of the magnetic head is low. In this case, it is possible to distinguish, from the measured results, the effects of the write system from the effects of the read system, by using the recording density (BPI) at which the effects of the transfer rate are reduced.

Next, a description will be given of each embodiment of the head evaluation method, the magnetic storage apparatus and the computer-readable storage medium according to the present invention, by referring to the drawings.

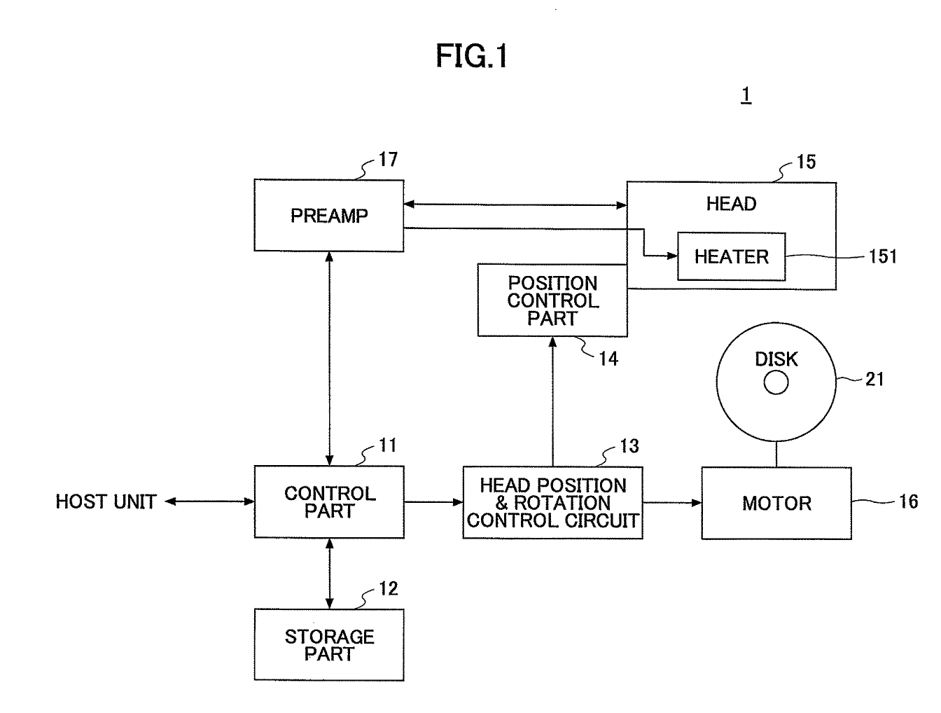

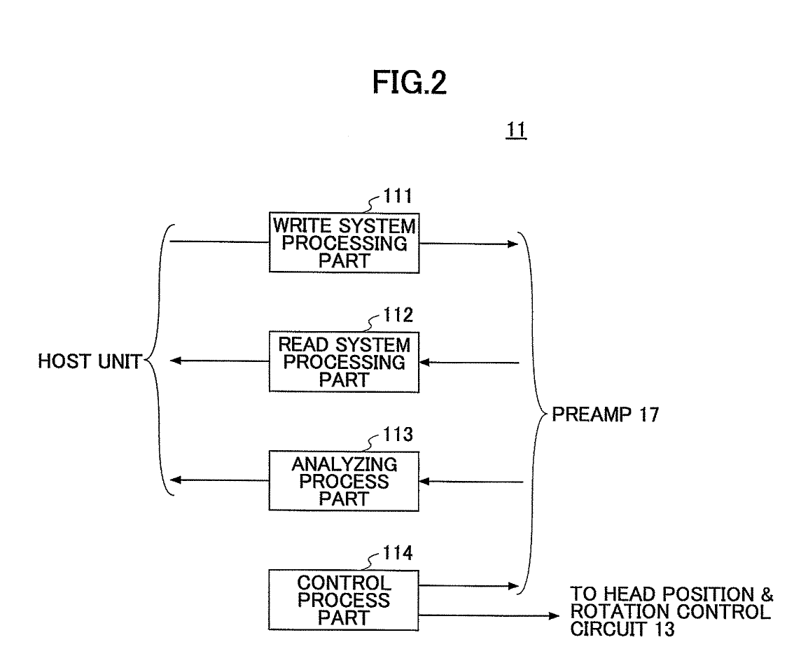

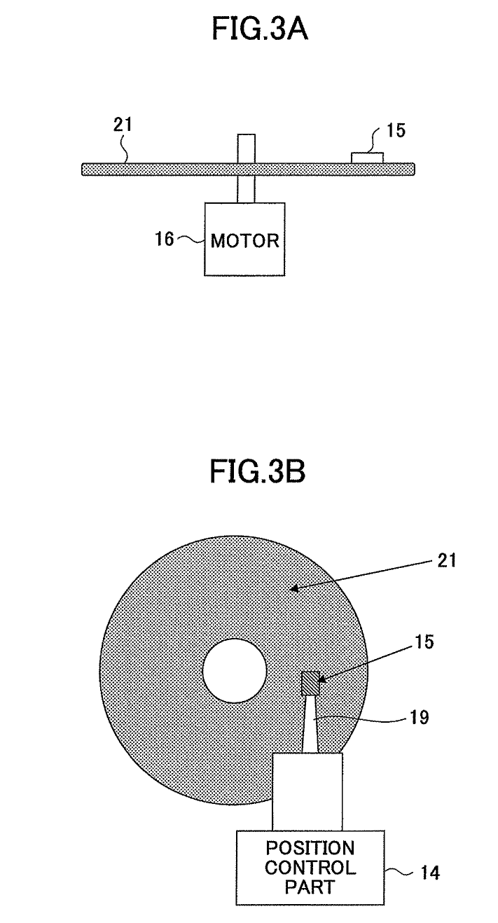

A description will be given of the magnetic storage apparatus in an embodiment of the present invention, by referring to FIGS. 1 through 3. In this embodiment, the present invention is applied to a magnetic disk apparatus which is provided with a Dynamic Flying Height (DFH) type magnetic head. FIG. 1 is a block diagram showing a part of the magnetic disk apparatus, and FIG. 2 is a block diagram showing a structure of a control part shown in FIG. 1. FIGS. 3A and 3B respectively are diagrams showing a relationship between a magnetic disk and a magnetic head.

A magnetic disk apparatus (or disk drive) 1 has a control part 11, a storage part 12, a head position and rotation control circuit 13, a position control part 14, a magnetic head 15, a spindle motor 16 and a preamplifier 17 which are connected as shown in FIG. 1, and a magnetic disk 21. It is assumed for the sake of convenience in FIG. 1 that the number of magnetic heads 15 and the number of magnetic disks 21 are both one, but each of the numbers may be two or more. A heater 151 is provided on the magnetic head 15, and a floating amount (or, spacing) of the magnetic head 15 with respect to the surface of the magnetic disk 21 can be controlled, that is, the so-called DFH control, can be carried out by controlling the amount of heat generated from the heater 151. The magnetic head 15 has a known structure including a write head and a read head.

The control part 11 is connected to a host unit (not shown) via an interface. The control part 11 may be formed by a processor such as a Micro Processing Unit (MPU) or a Central Processing Unit (CPU). In this embodiment, the storage part 12 includes a memory such as a Random Access Memory (RAM) and a Read Only Memory (ROM). If the control part 11 is formed by the processor, the storage part 12 provide a region for storing programs to be executed by the processor, a region for storing data used by operations executed by the processor, intermediate data of the operations and the like, and a region for storing analysis results and/or evaluation results which will be described later. The storage part 12 also provides a buffer region for temporarily storing write data input from the host unit and read data output to the host unit.

As shown in FIG. 2, the control part 11 includes a write system process part 111, a read system process part 112, an analyzing process part 113, and a control process part 114. The process parts 111 through 114 may be formed by software, but it is of course possible to form the write system process part 111 and the read system process part 112 by a hardware processing part. The write system process part 111 subjects the write data which is input from the host unit to a predetermined signal processing, and supplies the processed write data to the magnetic head 15 via the preamplifier 17, in order to write the write data on the magnetic disk 21. The read system process part 112 subjects the read data which is read from the magnetic disk 21 by the magnetic head 15 and input to the preamplifier 17 to a predetermined signal processing, and outputs the processed signal to the host unit.

The control process part 114 carries out a heater control, a head position control, and a disk rotation control depending on commands received from the host unit. The heater control controls the amount of heat generated from the heater 151 by supplying a driving current to the heater 151 via the preamplifier 17, in order to control the floating amount of the magnetic head 15 with respect to the magnetic disk 21. The head position control controls the position control part 14, including a voice coil motor, for example, via the head position and rotation control circuit 13, in order to control the radial position of the magnetic head 15 on the magnetic disk 21. The radial position of the magnetic head 15 on the magnetic disk 21 (including fixing of the radial position) and the recording density (TPI: Track Per Inch) in a sub scan direction of the magnetic head 15 (or, a radial direction of the magnetic disk 21) can be controlled by this head position control. The disk rotation control controls the rotational speed of the magnetic disk 21 by controlling the spindle motor 16 via the head position and rotation control circuit 13. The rotational speed of the magnetic disk 21 (or, the number of revolutions of the magnetic disk 21 per unit time) and the recording density (BPI) in the main scan direction of the magnetic head 15 (or, in the circumferential direction of the magnetic disk 21) can be controlled by this disk rotation control.

The analyzing process part 113 rotates the magnetic disk 21 at a first rotational speed and causes the magnetic head 15 to write and read the data, and thereafter rotates the magnetic disk 21 at a second rotational speed which is lower than the first rotational speed and causes the magnetic head 15 to write and read the data while maintaining the floating amount of the magnetic head 15 with respect to the magnetic disk 21 the same as that when the magnetic disk 21 is rotated at the first rotational speed, to thereby obtain a first measured result indicating a change in the read data. In addition, the analyzing process part 113 rotates the magnetic disk 21 at the second rotational speed and causes the magnetic head 15 to write and read the data, and thereafter rotates the magnetic disk 21 at the first rotational speed which is higher than the first rotational speed and causes the magnetic head 15 to write and read the data while maintaining the floating amount of the magnetic head 15 with respect to the magnetic disk 21 the same as that when the magnetic disk 21 is rotated at the second rotational speed, to thereby obtain a second measured result indicating a change in the read data. The first and second measured results are stored in the storage part 12, and are output to the host unit if necessary. The magnetic head 15 can be evaluated based on the first and second measured results, and the evaluation of the magnetic head 15 may be made automatically by the analyzing process part 113 or, manually by a user or, semi-automatically in an interactive manner by the user and the analyzing process part 113. An evaluation result of the magnetic head 15 is stored in the storage part 12, and is output to the host unit.

FIGS. 3A and 3B respectively are a side view and a plan view showing the radial position of the magnetic head 15 on the magnetic disk 21. As shown in FIG. 3B, the magnetic head 15 is provided on a tip end of an arm 19, and the arm 19 is pivoted or turned about a fulcrum of the arm 19 by the control of the position control part 14, to thereby determine the radial position and the yaw angle of the magnetic head 15 on the magnetic disk 21.

The basic structure of the magnetic disk apparatus 1 is not limited to the structure shown in FIG. 1, and various other known structures may be employed. The magnetic disk apparatus 1 may have any structure as long as it is possible to carry out the heater control, the head position control, and the disk rotation control described above.

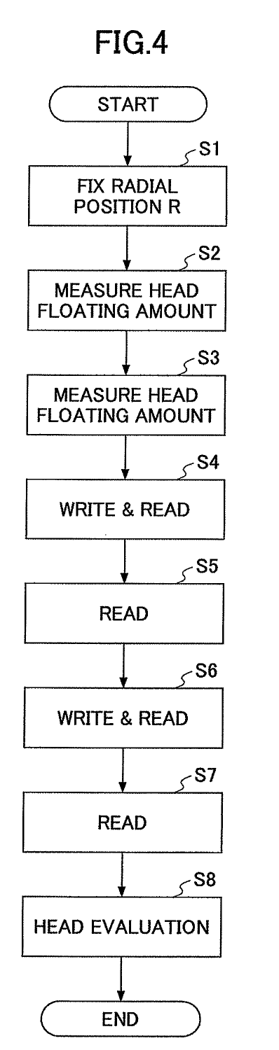

Next, a description will be given of the head evaluation method of this embodiment, by referring to FIGS. 4 through 12.

FIG. 4 is a flow chart for explaining the head evaluation method. The process shown in FIG. 4 is started at an arbitrary timing in response to a command from the host unit, for example.

In FIG. 4, a step S1 controls the position control part 14 via the head position and rotation control circuit 13, to fix a radial position R of the magnetic head 15 on the magnetic disk 21. For example, the radial position R is fixed to a position 25.68 mm from a center of the magnetic disk 21 having a diameter of 2.5 inches, and the yaw angle or skew is also fixed to a fixed value of 0.37 degrees, for example. The yaw angle or skew refers to a deviation of a direction which is perpendicular to a head width direction in which a gap of the magnetic head 15 extends, with respect to a direction in which the track is formed on the magnetic disk (that is, the main scan direction of the magnetic head 15). If a stable measurement of the characteristic at the time of the write and at the time of the read is taken into consideration, it is desirable that the radial position R is located at a central part of a data zone on the magnetic disk 21 where the data is recorded and where the yaw angle or skew is approximately zero degree.

A step S2 controls the spindle motor 16 via the head position and rotation control circuit 13, sets the peripheral speed of the magnetic disk 21 to 32.27 (m/s), for example, and measures and stores the floating amount (nm) of each of two magnetic heads H1 and H2 in the storage part 12. The floating amount may be measured directly or, measured indirectly by controlling the heater 151 via the preamplifier 17 to make the magnetic head 15 contact the magnetic disk 21. Because a relationship between the driving current supplied to the heater 151 and a corresponding projecting amount of the magnetic head 15 with respect to the magnetic disk 21 can be obtained in advance, it is possible to obtain the projecting amount of the magnetic head 15, that is, the floating amount of the magnetic head 15, from the driving current at the time when the magnetic head 15 contacts the magnetic disk 21. The contact between the magnetic head 15 and the magnetic disk 21 can be detected from the thermal asperity or the like. Similarly, a step S3 controls the spindle motor 16 via the head position and rotation control circuit 13, sets the peripheral speed of the magnetic disk 21 to one or a plurality of speeds higher than the peripheral speed set in the step S2, and measures and stores the floating amount (nm) of each of two magnetic heads H1 and H2 in the storage part 12. For example, the step S3 sets the peripheral speed to 36.30 (m/s) and 40.34 (m/s), and measures and stores the floating amount (nm) of each of two magnetic heads H1 and H2 in the storage part 12. Hence, even in a case where a plurality of magnetic heads 21 are provided within the magnetic disk apparatus 1, it is possible to measure and store the characteristic of each magnetic head 15 in the storage part 12. Of course, the accuracy of the characteristic that is measured improves as the number of kinds of peripheral speeds used to measure the characteristic of each magnetic head 15 increases.

For example, the characteristics of the two magnetic heads H1 and H2 for a case where the BPI is fixed to BPI=400 k become as shown in the following Table under the conditions described above. In this particular example, the characteristics of the magnetic heads H1 and H2 are measured at three kinds of peripheral speeds.

TABLE 1

| | | | Floating | Floating |
|---|---|---|---|---|
| Rotational | Peripheral | Transfer | Amount | Amount |
| Speed | Speed | Rate | of Head | of Head |
| (rpm) | (m/s) | (MB/s) | H1 (nm) | H2 (nm) |
| 15000 | 40.34 | 74.41 | 7.89 | 6.83 |
| 13500 | 36.30 | 36.30 | 6.84 | 5.82 |
| 12000 | 32.27 | 63.52 | 6.00 | 4.91 |

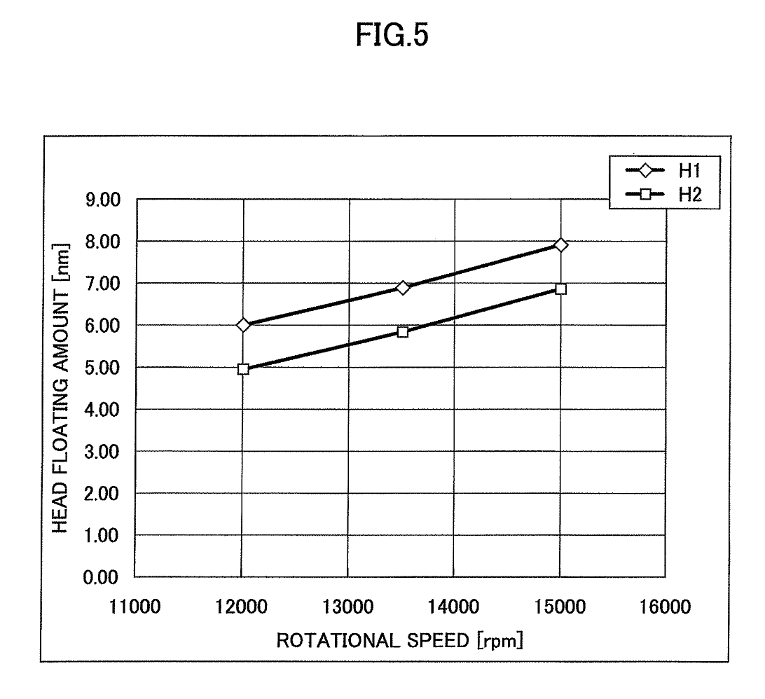

FIG. 5 is a diagram showing a relationship between the floating amounts of the magnetic heads H1 and H2 and the rotational speed of the magnetic disk 21. In FIG. 5, the ordinate indicates the head floating amount (nm), and the abscissa indicates the rotational speed (rpm) of the magnetic disk 21. In FIG. 5, a symbol “⋄” indicates the characteristic of the magnetic head H1, and a symbol “∘” indicates the characteristic of the magnetic head H2. By obtaining the relationship shown in FIG. 5 by interpolating the characteristics measured in the step S2 and S3, and storing this relationship in the storage part 12, it is possible to utilize the stored characteristics when carrying out the control to maintain the floating amount of the magnetic head 15 constant as will be described later in the specification.

Returning now to the description of FIG. 4, a step S4 controls the spindle motor 16 via the head position and rotation control circuit 13, writes the write data on the magnetic disk 21 by the magnetic head 15 after setting the peripheral speed of the magnetic disk 21 to a relatively low value (for example, a rotational speed of 13757 (rpm)), and reads the written data by the magnetic head 15 and stores the read data in the storage part 12. In addition, a step S5 controls the spindle motor 16 via the head position and rotation control circuit 13, writes the write data on the magnetic disk 21 by the magnetic head 15 after setting the peripheral speed of the magnetic disk 21 to a relatively high value (for example, a rotational speed of 15438 (rpm)), and reads the written data by the magnetic head 15 and stores the read data in the storage part 12. The steps S4 and S5 control the position control part 14 via the head position and rotation control circuit 13 in order to fix both the radial position R of the magnetic head 15 on the magnetic disk 21 and the yaw angle or skew of the magnetic head 15. The fixed values of the radial position R and the yaw angle or skew are the same as the fixed values used in the step S1. Furthermore, in order to prevent the floating amount of the magnetic head 15 from increasing by an amount corresponding to the increase in the peripheral speed (rotational speed) of the magnetic disk 21, the step S5 supplies an appropriate driving current to the heater 151 via the preamplifier 17 using the relationship which is shown in FIG. 5 for the magnetic head H2, for example, and is stored in the storage part 12, so that the floating amount becomes the same as that at the time when the step S4 is carried out and is maintained the same as the floating amount before the peripheral speed of the magnetic disk 21 was increased.

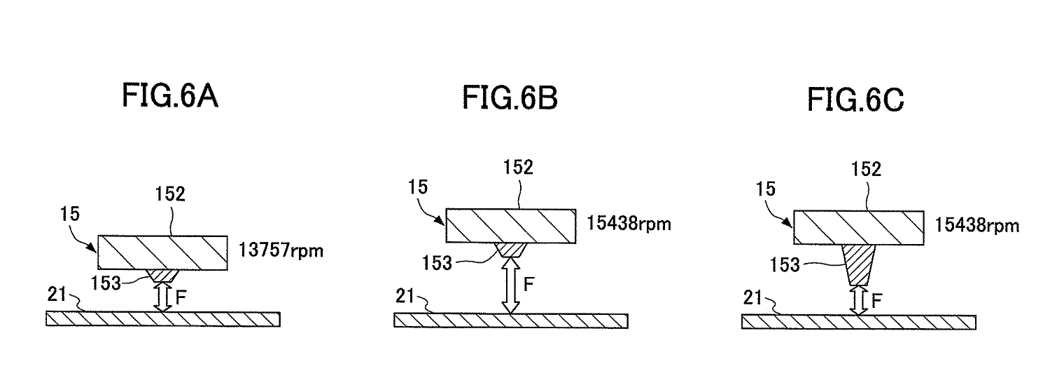

FIGS. 6A, 6B and 6C respectively are diagrams for explaining the control of the floating amount of the magnetic head 15. FIG. 6A shows the floating amount of the magnetic head 15 in the step S4, FIG. 6B shows the floating amount of the magnetic head 15 for a case where the floating amount is not controlled in the step S5, and FIG. 6C shows the floating amount of the magnetic head 15 for a case where the floating amount is controlled in the step S5. In FIGS. 6A, 6B and 6C, a reference numeral 152 denotes a slider of the magnetic head 15, a reference numeral 153 denotes the read head of the magnetic head 15, and F denotes the floating amount of the magnetic head 15.

A step S6 shown in FIG. 4 controls the spindle motor 16 via the head position and rotation control circuit 13, writes the write data on the magnetic disk 21 by the magnetic head 15 after setting the peripheral speed of the magnetic disk 21 to a relatively high value (for example, a rotational speed of 15438 (rpm)), and reads the written data by the magnetic head 15 and stores the read data in the storage part 12. In addition, a step S7 controls the spindle motor 16 via the head position and rotation control circuit 13, writes the write data on the magnetic disk 21 by the magnetic head 15 after setting the peripheral speed of the magnetic disk 21 to a relatively low value (for example, a rotational speed of 13757 (rpm)), and reads the written data by the magnetic head 15 and stores the read data in the storage part 12. The steps S6 and S7 control the position control part 14 via the head position and rotation control circuit 13 in order to fix both the radial position R of the magnetic head 15 on the magnetic disk 21 and the yaw angle or skew of the magnetic head 15. The fixed values of the radial position R and the yaw angle or skew are the same as the fixed values used in the step S1. Furthermore, in order to prevent the floating amount of the magnetic head 15 from decreasing by an amount corresponding to the decrease in the peripheral speed (rotational speed) of the magnetic disk 21, the step S7 supplies an appropriate driving current to the heater 151 via the preamplifier 17 using the relationship which is shown in FIG. 5 and is stored in the storage part 12, so that the floating amount becomes the same as that at the time when the step S6 is carried out and is maintained the same as the floating amount before the peripheral speed of the magnetic disk 21 was decreased.

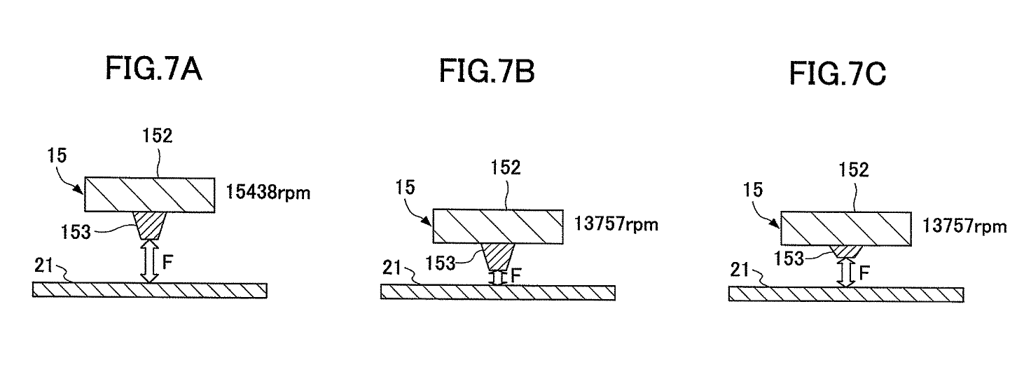

FIGS. 7A, 7B and 7C respectively are diagrams for explaining the control of the floating amount of the magnetic head 15. FIG. 7A shows the floating amount of the magnetic head 15 in the step S6, FIG. 7B shows the floating amount of the magnetic head 15 for a case where the floating amount is not controlled in the step S7, and FIG. 7C shows the floating amount of the magnetic head 15 for a case where the floating amount is controlled in the step S7. In FIGS. 7A, 7B and 7C, a reference numeral 152 denotes a slider of the magnetic head 15, a reference numeral 153 denotes the read head of the magnetic head 15, and F denotes the floating amount of the magnetic head 15.

The steps S6 and S7 may be carried out before the steps S4 and S5.

A step S8 evaluates the primary factor of the characteristic change of the magnetic head 15 depending only on the transfer rate, and the process ends. This evaluation in the step S8 is based on (i) the differences between the case where the data is read at the relatively low peripheral speed (rotational speed) and the case where the data is read at the relatively high peripheral speed (rotational speed) which are obtained from the measured results of the steps S4 and S5, (ii) the differences between the case where the data is read at the relatively high peripheral speed (rotational speed) and the case where the data is read at the relatively low peripheral speed (rotational speed) which are obtained from the measured results of the steps S6 and S7, (iii) the differences between the case where the data is written at the low BPI and the case where the data is written at the high BPI which are obtained from the measured results of the steps S4 through S7, and the like. This evaluation may be carried out automatically by the analyzing process part 113 or, manually by the user or, semi-automatically in an interactive manner by the user and the analyzing process part 113. Accordingly, it is possible to correctly evaluate the deterioration of the characteristic of the magnetic head 15 as the transfer rate is increased. More particularly, by comparing the measured results obtained at the low BPI state and at the high BPI state in the steps S4 and S5, and comparing the measured results at the high BPI state and at the low BPI state in the steps S6 and S7, it is possible to obtain the BPI at which the effects of the transfer rate are reduced and thus obtain an optimum BPI for the magnetic head 15. In this case, by using the BPI at which the effects of the transfer rate are reduced, it becomes possible to distinguish, from the measured results, the effects of the write system including the write system process part 111 from the effects of the read system including the read system process part 112, as will be described hereunder.

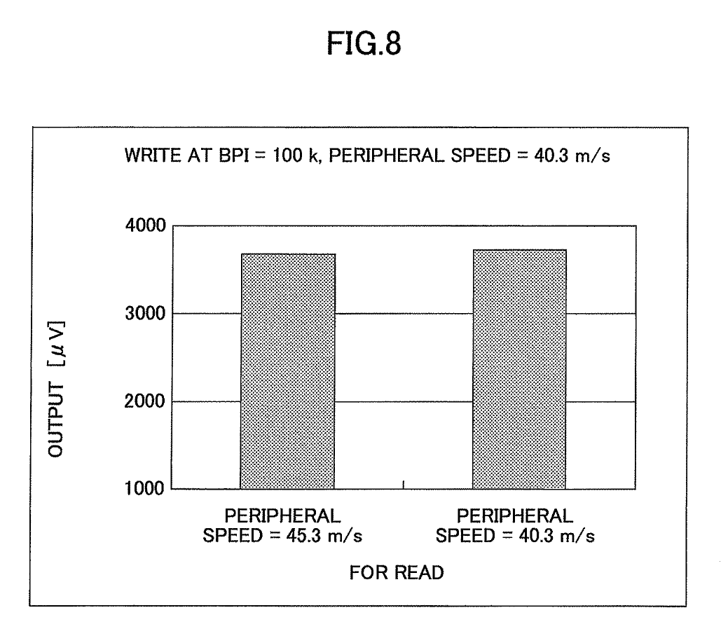

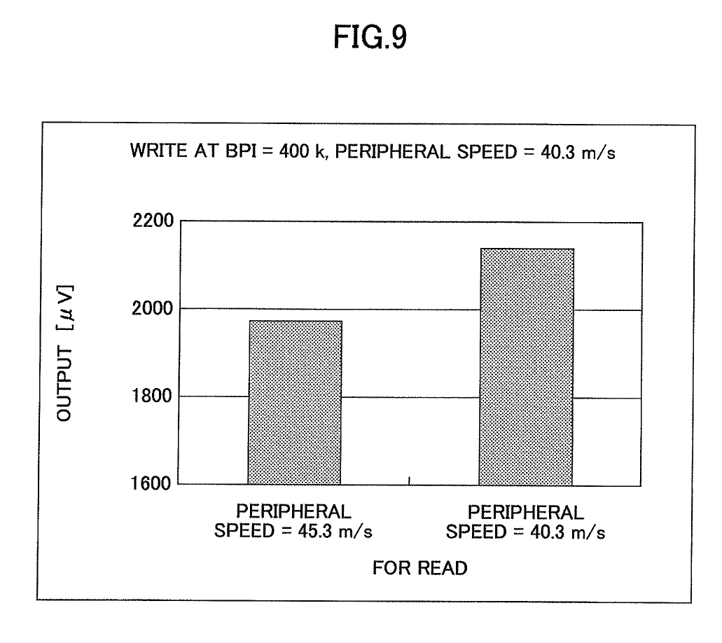

FIG. 8 is a diagram showing an output (μV) of the magnetic head 15 at the time of reading when the data write and read in the step S4 are carried out at a peripheral speed of 40.3 (m/s) and the data read in the step S5 is carried out at a peripheral speed of 45.3 (m/s), at a BPI of 100 k. In addition, FIG. 9 is a diagram showing an output (μV) of the magnetic head 15 at the time of reading when the data write and read in the step S4 are carried out at a peripheral speed of 40.3 (m/s) and the data read in the step S5 is carried out at a peripheral speed of 45.3 (M/s), at a BPI of 400 k. In FIGS. 8 and 9, the ordinate indicates the output (μV) of the magnetic head 15 at the time of reading, and the abscissa indicates the peripheral speed (m/s) of the magnetic disk 21 at the time of the reading.

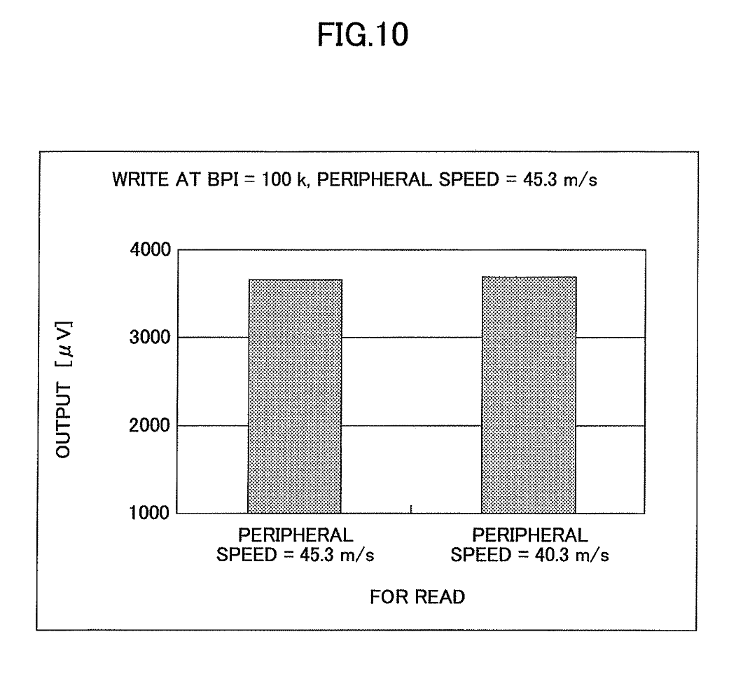

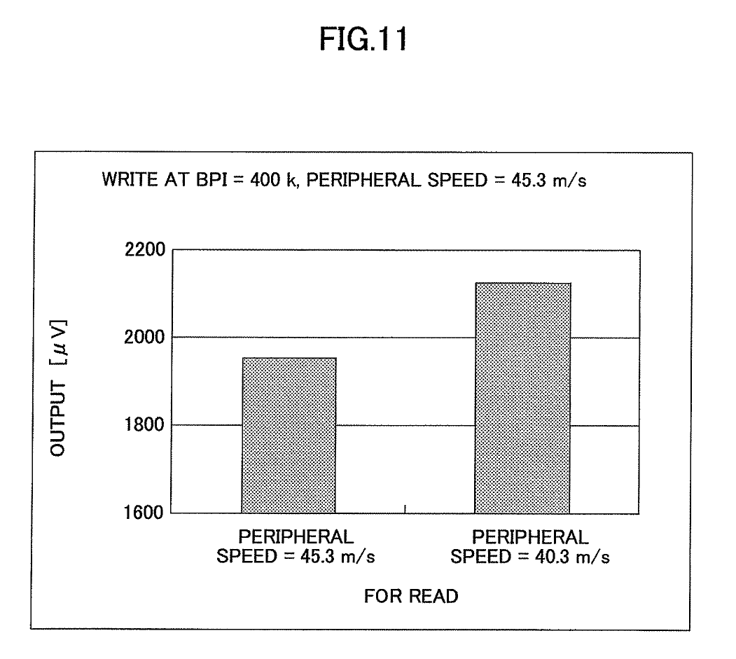

FIG. 10 is a diagram showing an output (μV) of the magnetic head 15 at the time of reading when the data write and read in the step S6 are carried out at a peripheral speed of 45.3 (m/s) and the data read in the step S7 is carried out at a peripheral speed of 40.3 (m/s), at a BPI of 100 k. In addition, FIG. 11 is a diagram showing an output (μV) of the magnetic head 15 at the time of reading when the data write and read in the step S6 are carried out at a peripheral speed of 45.3 (m/s) and the data read in the step S7 is carried out at a peripheral speed of 40.3 (m/s), at a BPI of 400 k. In FIGS. 10 and 11, the ordinate indicates the output (μV) of the magnetic head 15 at the time of reading, and the abscissa indicates the peripheral speed (m/s) of the magnetic disk 21 at the time of the reading.

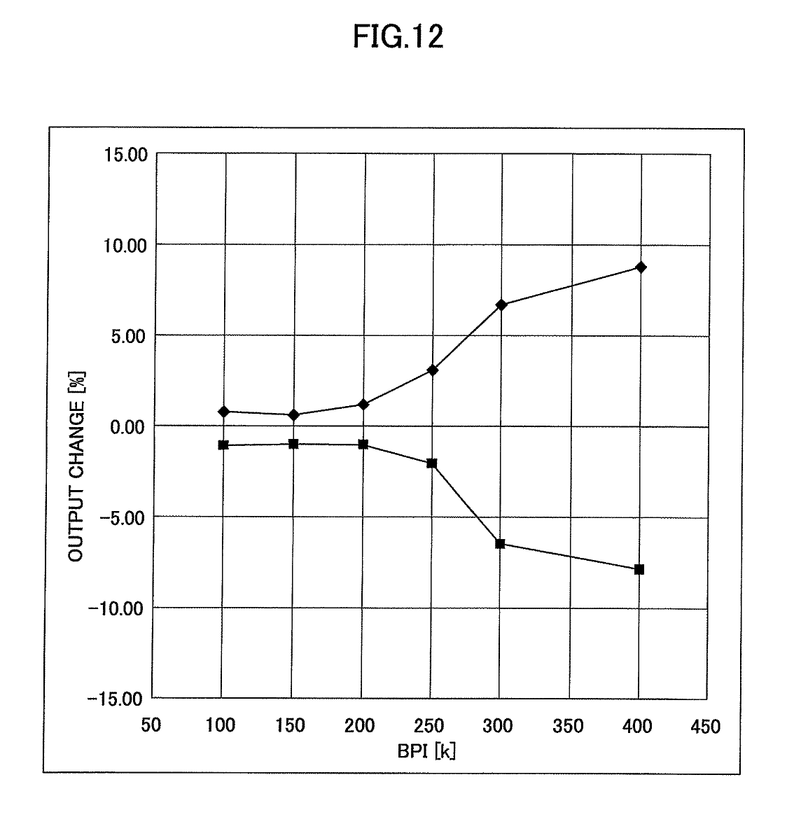

Furthermore, FIG. 12 is a diagram showing measured results of FIGS. 8 through 11 together. In FIG. 12, symbols “▪” indicate the measured results of FIGS. 8 and 9, and symbols “♦” indicate the measured results of FIGS. 10 and 11. In FIG. 12, the ordinate indicates the output change (%) of the magnetic head 15, and the abscissa indicates the BPI (k).

In the case of FIGS. 8 through 12, the effects caused by different transfer rates cannot be seen at BPI=100 k. However, as the BPI is increased from 100 k, the output change becomes larger and the effects of the transfer rate become visible. In this particular case, because the output of the magnetic head 15 at the time of the reading is the same even if the data written under conditions where the transfer rates are different are read, it may be judged in the step S8 that the output deterioration in this particular case is caused by the effects of the read system and not the write system. Such a judgement may be made automatically by the analyzing process part 113 or, manually by the user or, semi-automatically in an interactive manner by the user and the analyzing process part 113.

The program for causing the computer to realize the function related to the head evaluation of the magnetic disk apparatus 1 described above or, each procedure of the head evaluation method described above, may be stored in a computer-readable storage medium. In this case, the storage part 12 itself, shown in FIG. 1, may form the computer-readable storage medium. Alternatively, the program which is stored in another computer-readable storage medium may be installed into the storage part 12. The computer may be formed by a general-purpose computer, and may be formed by the processor forming the control part 11 shown in FIG. 1, for example.

In the embodiment described above, the magnetic disk apparatus may be a dedicated apparatus designed exclusively for evaluating the magnetic head. In this case, it is possible to contribute to the development of magnetic heads having a low dependency on the transfer rate, by evaluating various kinds of magnetic heads by the dedicated apparatus. In addition, since it is possible to obtain an optimum BPI for each magnetic head, it is possible to set this optimum BPI to the magnetic disk apparatus when the magnetic head is mounted to the magnetic disk apparatus.

On the other hand, the magnetic disk apparatus may be an apparatus which is used by the user after being forwarded. In this case, the optimum BPI for each magnetic head may be set to the magnetic disk apparatus at an arbitrary timing, and even if the characteristic of the magnetic head changes with time or aging, for example, it is possible to always set the optimum BPI for the state of the magnetic head. Moreover, it becomes possible to use the magnetic head which is highly dependent on the transfer rate for the high-density recording only in zones other than the data zones on the magnetic disk, and for the low-density recording in the data zones.

This application claims the benefit of a Japanese Patent Application No. 2008-019315 filed Jan. 30, 2008, in the Japanese Patent Office, the disclosure of which is hereby incorporated by reference.

Further, the present invention is not limited to these embodiments, but various variations and modifications may be made without departing from the scope of the present invention.

What is claimed is:

1. A head evaluation method comprising:
a first procedure obtaining a first measured result which indicates a change in read data, by rotating a magnetic disk at a first rotational speed and writing data on and reading data from the magnetic disk by a magnetic head, and reading the data from the magnetic disk by the magnetic head by rotating the magnetic disk at a second rotational speed which is higher than the first rotational speed while maintaining a floating amount of the magnetic head with respect to the magnetic disk the same as that when the magnetic disk is rotated at the first rotational speed;
a second procedure obtaining a second measured result which indicates a change in read data, by rotating the magnetic disk at the second rotational speed and writing data on and reading data from the magnetic disk by the magnetic head, and reading the data from the magnetic disk by the magnetic head by rotating the magnetic disk at the first rotational speed while maintaining the floating amount of the magnetic head with respect to the magnetic disk the same as that when the magnetic disk is rotated at the second rotational speed; and
an evaluation procedure evaluating the magnetic head based on the first and second measured results, and evaluating a primary factor of a characteristic change of the magnetic head depending solely on a transfer rate.

2. The head evaluation method as claimed in claim 1, wherein said evaluation procedure obtains a recording density at which effects of the transfer rate are reduced, by comparing the first measured result which is obtained in a state where a recording density of the magnetic head in a circumferential direction of the magnetic disk is low and the first measured result which is obtained in a state where the recording density of the magnetic head in the circumferential direction of the magnetic disk is high, and comparing the second measured result which is obtained in the state where the recording density of the magnetic head in the circumferential direction of the magnetic disk is high and the second measured result which is obtained in the state where the recording density of the magnetic head in the circumferential direction of the magnetic disk is low.

3. The head evaluation method as claimed in claim 1, wherein said evaluation procedure uses a recording density at which effects of the transfer rate are reduced in order to distinguish, from the first and second measured results, effects of a write system of the magnetic disk apparatus from effects of a read system of the magnetic disk apparatus.

4. The head evaluation method as claimed in claim 1, wherein said first and second procedures control the floating amount of the magnetic head with respect to the magnetic disk by a driving current supplied to a heater of the magnetic head.

5. The head evaluation method as claimed in claim 4, wherein said first and second procedures control the floating amount of the magnetic head with respect to the magnetic disk by the driving current supplied to the heater of the magnetic head, based on a relationship between a floating amount of the magnetic head and the rotational speed of the magnetic disk which are measured in advance.

6. A magnetic storage apparatus comprising:
a magnetic head having a heater;
a position control part configured to control a radial position of the magnetic head on a magnetic disk;
a rotation control circuit configured to control a rotational speed of the magnetic disk;
a storage part configured to store a relationship between a floating amount of the magnetic head with respect to the magnetic disk and a rotational speed of the magnetic disk which are measured in advance;
a control process part configured to obtain a first measured result which indicates a change in read data, by rotating the magnetic disk at a first rotational speed and writing data on and reading data from the magnetic disk by the magnetic head, and reading the data from the magnetic disk by the magnetic head by rotating the magnetic disk at a second rotational speed which is higher than the first rotational speed while maintaining a floating amount of the magnetic head with respect to the magnetic disk the same as that when the magnetic disk is rotated at the first rotational speed, and to obtain a second measured result which indicates a change in read data, by rotating the magnetic disk at the second rotational speed and writing data on and reading data from the magnetic disk by the magnetic head, and reading the data from the magnetic disk by the magnetic head by rotating the magnetic disk at the first rotational speed while maintaining the floating amount of the magnetic head with respect to the magnetic disk the same as that when the magnetic disk is rotated at the second rotational speed; and
an evaluating process part configured to evaluate the magnetic head based on the first and second measured results, and to evaluate a primary factor of a characteristic change of the magnetic head depending solely on a transfer rate,
wherein said control process part controls the floating amount of the magnetic head with respect to the magnetic disk by controlling a driving current supplied to the heater based on the relationship stored in said storage part.

7. The magnetic storage apparatus as claimed in claim 6, wherein said evaluating process part obtains a recording density at which effects of the transfer rate are reduced, by comparing the first measured result which is obtained in a state where a recording density of the magnetic head in a circumferential direction of the magnetic disk is low and the first measured result which is obtained in a state where the recording density of the magnetic head in the circumferential direction of the magnetic disk is high, and comparing the second measured result which is obtained in the state where the recording density of the magnetic head in the circumferential direction of the magnetic disk is high and the second measured result which is obtained in the state where the recording density of the magnetic head in the circumferential direction of the magnetic disk is low.

8. The magnetic storage apparatus as claimed in claim 6, further comprising:
a write system process part configured to process data to be written on the magnetic disk by the magnetic head; and
a read system process part configured to process data read from the magnetic disk by the magnetic head,
wherein said evaluating process part uses a recording density at which effects of the transfer rate are reduced in order to distinguish, from the first and second measured results, effects of the write system process part from effects of the read system process part.

9. A computer-readable storage medium storing a program which, when executed by a computer, causes the computer to perform a process comprising:
a first procedure obtaining a first measured result which indicates a change in read data, by rotating a magnetic disk at a first rotational speed and writing data on and reading data from the magnetic disk by a magnetic head, and reading the data from the magnetic disk by the magnetic head by rotating the magnetic disk at a second rotational speed which is higher than the first rotational speed while maintaining a floating amount of the magnetic head with respect to the magnetic disk the same as that when the magnetic disk is rotated at the first rotational speed;
a second procedure obtaining a second measured result which indicates a change in read data, by rotating the magnetic disk at the second rotational speed and writing data on and reading data from the magnetic disk by the magnetic head, and reading the data from the magnetic disk by the magnetic head by rotating the magnetic disk at the first rotational speed while maintaining the floating amount of the magnetic head with respect to the magnetic disk the same as that when the magnetic disk is rotated at the second rotational speed; and
an evaluation procedure evaluating the magnetic head based on the first and second measured results, and evaluating a primary factor of a characteristic change of the magnetic head depending solely on a transfer rate.

10. The computer-readable storage medium as claimed in claim 9, wherein said evaluation procedure obtains a recording density at which effects of the transfer rate are reduced, by comparing the first measured result which is obtained in a state where a recording density of the magnetic head in a circumferential direction of the magnetic disk is low and the first measured result which is obtained in a state where the recording density of the magnetic head in the circumferential direction of the magnetic disk is high, and comparing the second measured result which is obtained in the state where the recording density of the magnetic head in the circumferential direction of the magnetic disk is high and the second measured result which is obtained in the state where the recording density of the magnetic head in the circumferential direction of the magnetic disk is low.

11. The computer-readable storage medium as claimed in claim 9, wherein said evaluation procedure uses a recording density at which effects of the transfer rate are reduced in order to distinguish, from the first and second measured results, effects of a write system of a magnetic disk apparatus from effects of a read system of the magnetic disk apparatus.

12. The computer-readable storage medium as claimed in claim 9, wherein said first and second procedures control the floating amount of the magnetic head with respect to the magnetic disk by a driving current supplied to a heater of the magnetic head.

13. The computer-readable storage medium as claimed in claim 12, wherein said first and second procedures control the floating amount of the magnetic head with respect to the magnetic disk by the driving current supplied to the heater of the magnetic head, based on a relationship between a floating amount of the magnetic head and the rotational speed of the magnetic disk which are measured in advance.
